(19) United States
(12) Patent Application Publication
(10) Pub. No.: US 2015/0075920 A1
(43) Pub. Date: Mar. 19, 2015

(54) Brake Release System

(71) Applicants: Gregory Alan Ward, Pasadena, CA (US); Wen C. Hsieh, Rancho Dominguez, CA (US)

(72) Inventors: Gregory Alan Ward, Pasadena, CA (US); Wen C. Hsieh, Rancho Dominguez, CA (US)

(21) Appl. No.: 14/026,368

(22) Filed: Sep. 13, 2013

(51) Int. Cl. B62L 3/00

(52) U.S. Cl. CPC B62L 3/00
USPC 188/24.11

(57) ABSTRACT

The present invention is a brake release system that prevents an over the handlebar accident caused by applying too much brake force to the front brake of a bicycle. By the retention and release of the brake cable housing or brake cable to partially release the front brake to prevent an over the handlebar accident. The present invention works by extending the length of the brake cable connected between the brake lever and the brake caliper on the front brake of a bicycle. The brake release system comprises a brake cable housing held by a piston. A hardened steel ball is used to keep the piston from moving and releasing the brake cable. A spring is used to push the ball against the piston. The amount of engagement of the ball with the piston and the spring force determine the release force. When the brakes are released, a spring automatically resets the brake release system when the rider releases the brake lever. The present invention is cost efficient.

### BACKGROUND OF THE INVENTION

1. Technical Field of the Invention

The present embodiment is related in general to systems for reducing the braking power of a two wheel vehicle, and in particular to a system for the reduction of the braking power by releasing brake cable tension and thereby preventing over the handlebar accidents due to excessive brake force.

2. Description of the Related Art

Braking systems have improved as materials and engineering know-how have evolved. All brakes, regardless of the mechanism, share a common thing that they increase the amount of brake friction allowing the rider to slow down or stop. Most brake problems result from excessive friction or poor installation of the cables or poor quality brakes. Traditional cantilever brakes used two cables, a main cable running down the centerline of the bike, and a second, transverse cable connecting the cantilever units on each side of the wheel. The main cable would pull upward on the middle of the transverse cable, causing the cantilever units to rotate inward. The operation of like brake systems such as applying the front brake only with too much pressure can lock up the front wheel and cause a forward rollover accident.

Conventional brake levers used with direct-pull cantilevers will not pull enough cable to stop in wet conditions without bottoming out against the handlebars. In dry conditions, they either won't work, or will grab too suddenly. The bicycle brake has been redesigned over the years to provide the rider with increased braking power. However, this increased braking power may be difficult for the inexperienced rider to control. Specifically, a bicycle brake with a very large braking power can possibly cause the bicycle wheel to lock up. This may cause the bicycle to skid for the inexperienced rider. With any braking system, failure to properly adjust, maintain, and use your brakes may result in a loss of control and injury.

One of the existing systems for reducing braking power describes a braking power modulator for a bicycle brake device. More specifically, the present invention relates to an adjustable braking power modulator, which can be mounted midway along a brake cable of a bicycle brake device to modulate the braking power corresponding to a stroke of an inner wire of the brake cable. The adjustable braking power modulator provides different braking powers to meet the needs of different riders or different road conditions. However, this system cannot be operated in all weather conditions. The system is not cost effective or convenient for use.

Another existing system for reducing braking power discloses a cable connecting apparatus that includes a cable sleeve adapted to receive the outer casing of a control cable; a guide having a first end portion and a second end portion for movably supporting the cable sleeve; and a biasing device for biasing the cable sleeve toward the second end portion of the guide. In another device, a connecting member is provided for connecting a portion of a first inner wire located between a first outer casing and a second outer casing to a portion of a second inner wire disposed between a third outer casing and a fourth outer casing, wherein the connector moves together with the first inner wire and the second inner wire. A position confirmation means allows the position of at least one of the first outer casing, the second outer casing, the third outer casing and the fourth outer casing to be visually confirmed. The system does not provide simple and reliable design.

Another existing system provides a device for a two wheeled vehicle with two independent cable operated brake systems consisting of two pivoting levers connecting the two cables operating the brake calipers via cables enclosed in casings from the hand lever to the calipers, one operating the front brake and one operating the rear brake. Regardless of which or both hand levers are applied first, the rear brake will be actuated before and with more force that to the front brake through the offset pivot point of the two levers, the fulcrum action will alter the length of the casing relative to the cable length of one brake and by tension transfer the differences of casing length to cable length on the opposite side and apply the brakes rear first with more force than front brake. However, this system requires no adjustment or maintenance over time.

Various other systems exist that reduce the brake power of a two wheel vehicle. One such system is a braking power modulator for a bicycle brake device. More specifically, the present invention relates to an adjustable braking power modulator, which can be mounted midway along a brake cable of a bicycle brake device to modulate a braking power corresponding to a stroke of an inner wire of the brake cable. The adjustable braking power modulator provides different braking powers to meet the needs of different riders or different road conditions. Various other systems use a spring to limit the force that a brake lever can transmit to a brake caliper. This is done by placing a spring on one end of a brake cable at either the lever end or the caliper end. When the rider moves the brake lever, some of the force is used to move the spring, not the brake cable, thus limiting the amount of force the brake cable transmits to the brake caliper. The disadvantage of these systems is that the braking power is limited all the time so that the performance of the braking system is limited. Thus the safety of the braking system is reduced.

Based on the foregoing, there is a need for a system that would prevent over the handlebar accidents when the front brake is applied too rapidly or aggressively. Such a needed system would reset automatically. Such a needed system would provide a simple and reliable design. Further, the system could be operated in all weather conditions. The system would require no adjustment or maintenance over time. Such a system would be installed in all types of bicycles and anywhere in a bicycle brake system. Finally, the system would be cost effective and convenient for use. The present invention overcomes prior art shortcomings by accomplishing these critical objectives.

### SUMMARY OF THE INVENTION

To minimize the limitations found in the prior art, and to minimize other limitations that will be apparent upon the reading of the specifications, the preferred embodiment of the present invention provides a device for brake power reduction of two-wheel vehicles.

The present embodiment is a brake release system. The brake release system comprises a brake cable, brake cable housing held by a piston. The piston is held in the latched position by the hardened steel ball. The hardened steel ball is pushed into the groove in the piston and held in place by a compression spring. The amount of spring force on the hardened steel ball and the amount of the hardened steel ball that is engaged in the groove determines the release force. The brake cable housing is held in place by the piston. When the brake cable is pulled quickly and the longitudinal force on the piston reaches the release force, the piston slides down the bore in the brake release housing. This action partially releases the brakes. A plurality of O-rings prevent water and debris from entering the housing. Pluralities of washers are available inside the cap. A compression spring is also seen inside the cap. The plurality of washers adjust the force the spring pushes on the hardened steel ball. The housing is made of a wall tubing and is also available in the brake release system. A changeable end cap is connected to a brake release housing. A noodle for V-brakes is present in the brake release system and is connected to the changeable end cap.

The brake release system works by extending the length of the brake cable connected between the brake lever and the brake caliper on the front brake of a bicycle. The method of extending the brake cable is to release the brake cable housing. The brake release system routes the brake cable through the center of the brake release system. This eliminated any side loads or friction on the brake cable during normal braking operation. The brake will feel the same to the rider during normal operation even with the brake release system installed on the bicycle.

A piston is used to hold the brake cable housing. A hardened steel ball is used to keep the piston from moving and releasing the brake cable. A spring is used to push the ball against the piston. The amount of engagement of the ball with the piston and the spring force determine the release force. When the brake is applied smoothly, the ball and piston can resist approximately two and a half times the brake lever load compared to when the rider aggressively applies the brake lever with the resulting shock load on the ball and piston. When the brake is applied smoothly, about 90% of the braking power can be achieved. When the brake is applied aggressively and rapidly, the brake releases at about 50% of its braking power.

The brake release system is a safety device for bicycles with cable actuated brakes. The brake release system prevents over the handlebar accidents on bicycles that result from applying the front brake too rapidly and aggressively. The front brake works normally with the brake release system when the brake lever is squeezed smoothly. The front brake applies about one third of its braking power after the brake release system releases the brake. The brake automatically resets when the brake lever is released.

The brake release system takes one half second from brake release to brake reset. The brake release system is a simple and reliable mechanical design. It has high reliability with no moving parts during normal braking. The brake release system has an enclosed design and can operate for years in all weather conditions. No adjustments or maintenance is needed over time. It is easy to confirm that the brake release system is functioning by rapidly squeezing the brake lever and seeing that the front brake is partially released. The brake release system works with all types of bicycles that have cable actuated brake including rim and disc brakes. The brake release system can be installed anywhere in the bicycle brake system including at the brake lever, the brake caliper or anywhere along the brake cable route.

The present embodiment is easy to install on new bicycles and can be retrofitted easily to existing bikes. The brake release system is cost efficient. Other features and advantages of the present invention will become apparent from the following more detailed description, taken in conjunction with the accompanying drawings, which illustrate, by way of example, the principles of the invention.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIGS. 1A and 1B is a cut-away perspective view of a brake release system in accordance with a preferred embodiment of the present invention for bicycles with V-brakes;

FIGS. 2A and 2B is a partial cut-away perspective view of the brake release system of the present invention for bicycles with mechanical disc brakes, caliper brakes or cantilever brakes;

FIGS. 3A and 3B is a partial cut-away perspective view of the brake release system of the present invention for any bicycle with cable actuated brakes where the brake release system can be mounted anywhere along the brake cable route;

FIGS. 4A and 4B is a partial cut-away perspective view of the brake release system of the present invention for bicycles with cable actuated brakes where the brake release system is mounted to the brake lever housing;

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

The following describes example embodiments in which the present invention may be practiced. This invention, however, may be embodied in many different ways, and the description provided herein should not be construed as limiting in any way. Among other things, the following invention may be embodied as methods or devices. As such, the present invention may take the form of an entirely hardware embodiment, or an embodiment combining software and hardware aspects such as when the brake release system is used in conjunction with a computer to form an antiskid system. The following detailed descriptions should not be taken in a limiting sense.

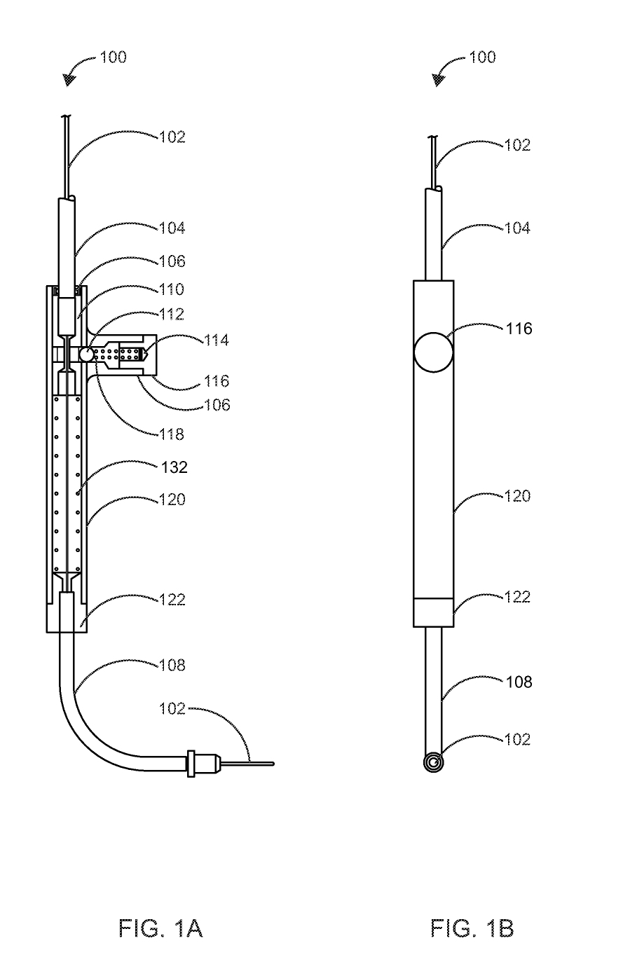

FIGS. 1A, 1B, 2A, 2B, 3A, 3B, 4A and 4B are of the same configuration except for the changeable end cap. The end cap is changed so the brake release system can be adapted to the many different kinds of bicycle brake systems that have cable actuated brakes. Referring to FIGS. 1A and 1B, the cut-away orthographic views of a brake release system 100 in accordance with a preferred embodiment of the present invention are illustrated and this configuration is for bikes with V-brakes. The brake release system 100 comprises a brake cable 102, a brake cable housing 104 held by a piston 110. The piston 110 is held in the latched position by the hardened steel ball 112. The hardened steel ball 112 is pushed into the groove in the piston 110 and held in place by compression spring 118. The amount of spring force on the hardened steel ball 112 and the amount of the hardened steel ball 112 that is engaged in the groove determines the release force. The brake cable housing 104 is held in place by the piston 110. When the brake cable 102 is pulled quickly and the longitudinal force on the piston 110 reaches the release force, the piston 110 slides down the bore in the housing 120. This action partially releases the brakes. An O-ring 106 is available to keep water and debris from entering the brake release housing 120. Pluralities of washers 114 are available inside the cap 116 to adjust the force of compression spring 118 on the hardened steel ball 112 pushing against the piston 110. Compression spring 118 is seen inside the cap 116. The wall tubing of housing 120 is also available in the brake release system. When the brake release system partially releases the brake, compression spring 132 pushes piston 110 back to the latched position when the brake lever is released. This action automatically resets the brake release system. A changeable end cap 122 is connected to the brake release housing 120. The curved portion of noodle 108 for V-brakes is attached to changeable end cap 122 and is shown in FIG. 1A.

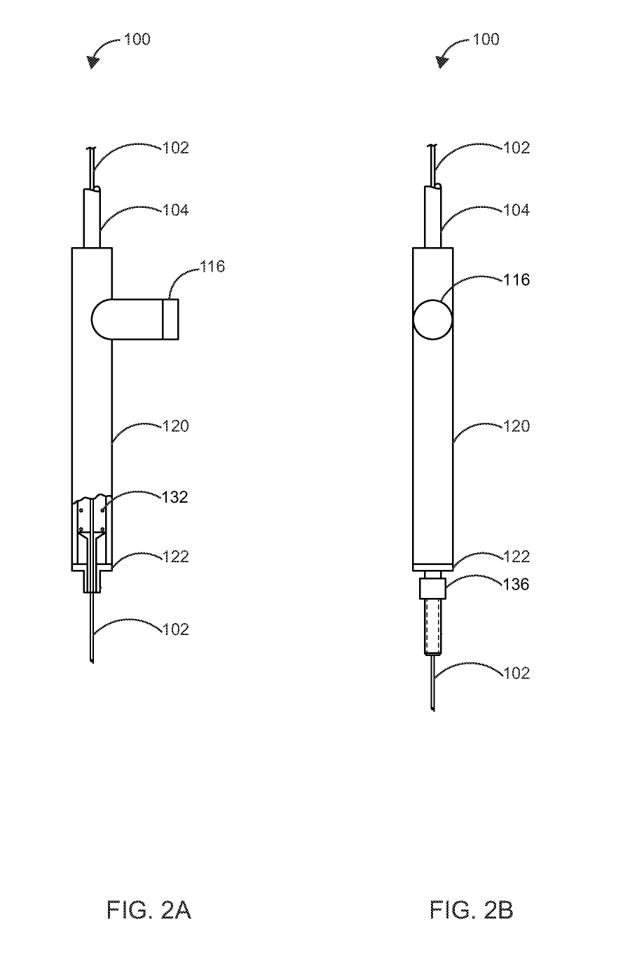

FIGS. 2A and 2B show the partial cut-away orthographic views of the brake release system 100. This configuration is for mounting the brake release system on mechanical disc brakes, caliper brakes and cantilever brakes. The brake cable 102 of the brake release system 100 is shown at the top and bottom of the brake release system 100. A brake cable housing 104 at the top of the brake release system 100 is shown in FIG. 2A. A cap 116 is also shown in FIG. 2A. A wall tubing housing 120, the compression spring 132, the changeable end cap 122 and the adapter 124 is also shown in FIG. 2A. In FIG. 2B the threaded adapter 136 that is part of the brake caliper is shown mating to the changeable end cap 122.

The brake release system 100 comprises the brake cable 102, a brake cable housing 104 held by piston 110 (not shown). Piston 110 is held in the latched position by the hardened steel ball 112 (not shown). The hardened steel ball 112 is pushed into the groove in the piston 110 and held in place by a compression spring 118 (not shown). Compression spring 118 is used to push the hardened steel ball 112 against the piston 110. The amount of spring force on the hardened steel ball 112 and the amount of the hardened steel ball 112 that is engaged in the groove determines the release force. The brake cable housing 104 is held in place by the piston 110. When the brake cable 102 is pulled quickly and the longitudinal force on the piston 110 reaches the release force, the piston 110 slides down the bore in the housing 120. This action partially releases the brakes. An O-ring (not shown) keeps water and debris from entering housing 120. Pluralities of washers (not shown) are available inside the cap 116. When the brake release system partially releases the brake, compression spring 132 pushes piston 110 back to the latched position when the brake lever is released. This action automatically resets the brake release system.

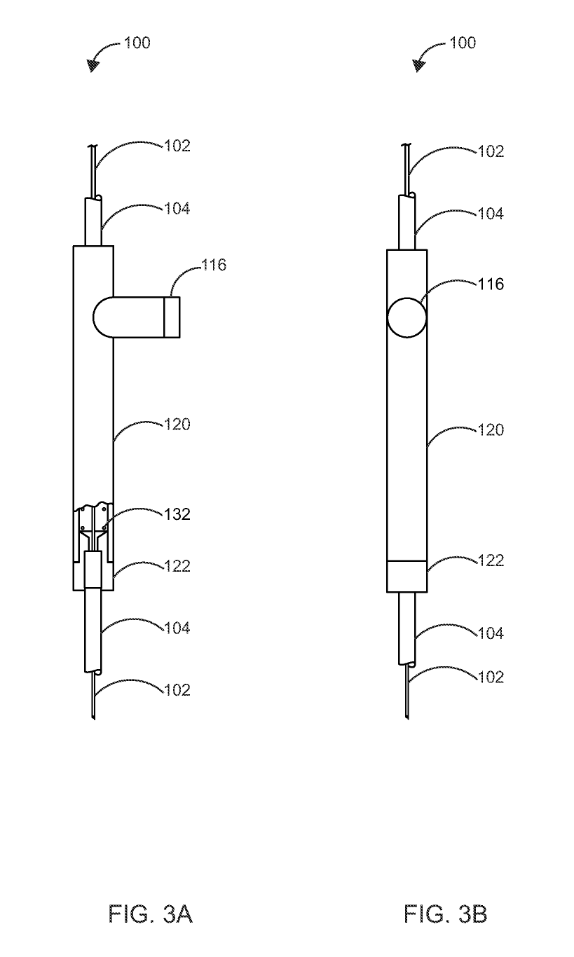

FIGS. 3A and 3B show the partial cut-away orthographic views of the brake release system 100. This configuration is for mounting the brake release system anywhere along the brake cable route. The brake cable 102 of the brake release system 100 is shown at the top and bottom of the brake release system 100. A brake cable housing 104 at the top and bottom of the brake release system 100 is shown in FIG. 3A. A cap 116 is also shown in FIG. 3A. A wall tubing housing 120, the compression spring 132 and the changeable cap 122 is also shown in FIG. 3A. The cable housing adapter 122, is sized to accept cable housing 104.

The brake release system 100 comprises the brake cable 102, a brake cable housing 104 held by a piston 110 (not shown). The piston is held in the latched position by the hardened steel ball 112 (not shown). The hardened steel ball 112 is pushed into the groove in the piston and held in place by a compression spring 118 (not shown). Compression spring 118 is used to push the hardened steel ball 112 against the piston 110. The amount of spring force on the hardened steel ball 112 and the amount of the hardened steel ball 112 that is engaged in the groove determines the release force. The brake cable housing 104 is held in place by piston 110. When the brake cable 102 is pulled quickly and the longitudinal force on the piston 110 reaches the release force, the piston 110 slides down the bore in the housing 120. This action partially releases the brakes. An O-ring (not shown) keeps water and debris from entering housing 120. Inside the cap 116 shown in FIG. 3A pluralities of washers (not shown) are available to adjust the force exerted by compression spring 118 on hardened steel ball 112. When the brake release system partially releases the brake, compression spring 132 pushes piston 110 back to the latched position when the brake lever is released. This action automatically resets the brake release system.

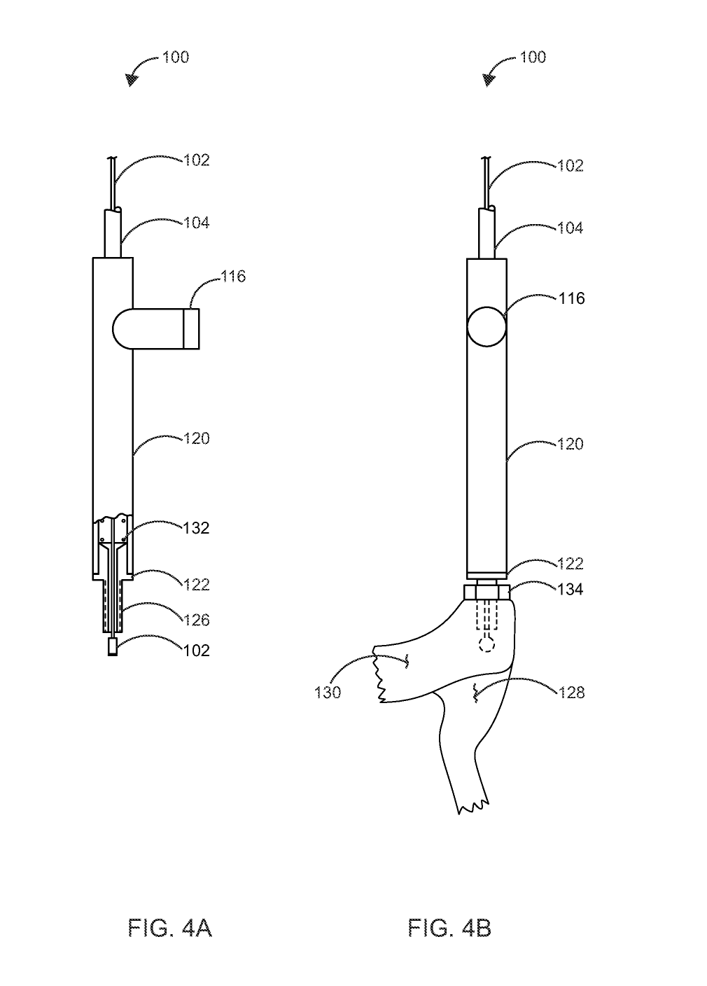

FIGS. 4A and 4B show the partial cut-away orthographic views of the brake release system 100. This configuration is for mounting the brake release system directly to the brake lever housing. The brake cable 102 of the brake release system 100 is shown at the top and bottom of the brake release system 100. A brake cable housing 104 at the top of the brake release system 100 is shown in FIG. 4A. The changeable end cap 122 that has threads 126 is also shown in FIG. 4A. Threads 126 on changeable end cap 122 allow the brake release system to be attached directly to the brake lever housing 130. Jam nut 134 locks the brake release system to the brake lever housing 130. A wall tubing housing 120 and the compression spring 132 are also shown in FIG. 4A. The brake lever 128 is shown in FIG. 4B.

The brake release system 100 comprises the brake cable 102, a brake cable housing 104 held by a piston 110 (not shown). The piston is held in the latched position by the hardened steel ball 112 (not shown). The hardened steel ball 112 is pushed into the groove in the piston and held in place by compression spring 118 (not shown). The compression spring is used to push the hardened steel ball 112 against the piston 110. The amount of spring force on the hardened steel ball 112 and the amount of the hardened steel ball 112 that is engaged in the groove of piston 110 determines the release force. The brake cable housing 104 is held in place by the piston 110. When the brake cable 102 is pulled quickly by brake lever 128 and the longitudinal force on the piston 110 reaches the release force, the piston 110 slides down the bore in the housing 120. This action partially releases the brakes. An O-ring (not shown) keeps water and debris from entering the brake release housing 120. Inside the cap 116 shown in FIG. 4A pluralities of washers (not shown) are available to adjust the force spring 118 pushes against hardened steel ball 112. When the brake release system partially releases the brake, compression spring 132 pushes piston 110 back to the latched position when brake lever 128 is released. This action automatically resets the brake release system.

The brake release system 100 has no moving parts during normal braking thus giving it high reliability. There are no batteries to maintain and no adjustments to be made. The front brake operates normally when the brake is applied smoothly. When the front brake is applied abruptly and aggressively in a panic stop situation, the front brake is released at approximately half of its maximum braking power. This prevents the rider from decelerating too quickly and possibly going over the handlebar. When the brake is released, the front brake is still operating with approximately 33% of the braking power being applied. The front brake automatically resets when the brake lever 128 is released by the rider. The brake release system 100 is also beneficial to any two wheel vehicles with cable actuated brakes that are prone to over the handlebar accidents. This includes electric bikes, electric scooters and small motor bikes. The brake release system 100 can also be used to limit the force being applied to any device using a flexible cable in a flexible housing.

The brake release system 100 works by extending the length of the brake cable 102 connected between the brake lever 128 and the brake caliper (not shown) on the front brake of a bicycle. The method of extending the brake cable 102 is to release the brake cable housing 104. The brake release system 100 routes the brake cable 102 through the center of the brake release system 100. This eliminated any side loads or friction on the brake cable 102 during normal braking operation. The brake will feel the same to the rider during normal operation when the brake release system 100 is installed on the bicycle.

Piston 100 (not shown) is used to hold the brake cable housing 104. A hardened steel ball 112 is used to keep the piston from moving and releasing the brake cable 102. A spring 118 is used to push the hardened steel ball 112 against the piston. The amount of engagement of the hardened steel ball 112 with the piston and the spring force determine the release force. When the brake is applied smoothly, the ball 112 and piston can resist approximately two and a half times the brake lever 128 load compared to when the rider aggressively applies the brake lever 128 with the resulting shock load on the ball 112 and piston. When the brake is applied smoothly, about 90% of the braking power can be achieved. When the brake is applied aggressively and rapidly, the brake release at about 50% of its braking power.

The brake release system 100 can be located anywhere along the path of the brake cable 102. It can be connected to the brake lever housing 130, the brake caliper (not shown) or anywhere along the brake cable 102 route. There is no cutting of the brake cable 102 or brake cable housing 104. It is easy to confirm that the brake release system 100 is operational by simply squeezing the brake lever 128 quickly to see that the front brake releases. The brake release system 100 is a simple design and is cost efficient.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A brake release system comprising:
a brake cable positioned inside a housing with a piston to hold the brake cable housing;
a brake lever, a brake caliper positioned on a front brake of a bicycle;
a hardened steel ball to keep the piston from moving and/or releasing the break cable;
a curved noodle for v-brakes positioned at changeable end cap of the brake release system; and
a changeable end cap connected to a brake release housing ;
whereby the brake release system works by extending the length of the brake cable connected between a brake lever and a brake caliper on the front brake of the bicycle.

2. The brake release system of claim 1 wherein the braking power of the front brake is available when the brake is applied smoothly.

3. The brake release system of claim 1 wherein a hardened steel ball is used to keep the piston from moving and releasing the brake cable.

4. The brake release system of claim 1 wherein the spring is used to push the hardened steel ball against the piston.

5. The brake release system of claim 1 wherein the amount of engagement of the hardened steel ball with the piston and the spring force determines the release force.

6. The brake release system of claim 1 wherein when the front brake is applied abruptly, the front brake is released at approximately half of its maximum braking power.

7. The brake release system of claim 1 wherein the front brake automatically resets when the brake lever is released by the rider.

8. A method for brake release system to prevent over the handlebar accidents caused by applying a large amount of brake force to the front brake of a bicycle having cable actuated brakes comprising:
a break cable positioned inside a housing with a piston to hold the brake cable housing;
a brake lever, a brake caliper positioned on a front brake of a bicycle;
a hardened steel ball to keep the piston from moving and/or releasing the brake cable;
a curved noodle for v-brakes attached to the changeable end cap;
a changeable end cap connected to a brake release system housing; and
O-rings positioned inside the brake release housing to prevent water and debris from entering the housing;
whereby the brake release system works by extending the length of the brake cable connected between a brake lever and a brake caliper on the front brake of a bicycle.

9. The method for brake release system of claim 8 wherein the extension of the brake cable is to release the brake cable housing.

10. The method for brake release system of claim 8 wherein the friction on the brake cable is eliminated during normal braking of the front brake.

11. The method for brake release system of claim 8 wherein the hardened steel ball is positioned inside the groove in the piston held in place by the compression spring.

12. The method for brake release system of claim 8 wherein when the brake is released and/or the rider holds the brake lever against the handlebar, the front brake needs to apply some braking to stop or slow down the bicycle.

13. The method for brake release system of claim 8 wherein attachments interfaces selected from a group consisting of: mechanical disc brakes, v-brakes, caliper brakes and cantilever brakes.

14. The method for brake release system of claim 8 wherein the reduction in the braking power is done by releasing the tension in the cable that actuates the front brake.

15. The method for brake release system of claim 7 wherein the reset of the brake release system is done automatically by using a spring that moves the piston back to the latched position when the rider releases the brake lever.
